(19) United States
(12) Patent Application Publication
(10) Pub. No.: US 2009/0083325 A1
(43) Pub. Date: Mar. 26, 2009

(54) SYSTEM AND METHOD FOR END TO END TESTING SOLUTION FOR MIDDLEWARE BASED APPLICATIONS

(75) Inventors: Vasu BELIDE, Hyderabad (IN); Raja George KAVALAM, Kerala (IN)

Correspondence Address: NIXON PEABODY, LLP, 401 9TH STREET, NW, SUITE 900, WASHINGTON, DC, 20004-2128, US

(73) Assignee: INFOSYS TECHNOLOGIES, LTD., Bangalore (IN)

(21) Appl. No.: 11/860,062

(22) Filed: Sep. 24, 2007

(51) Int. Cl. G06F 17/30

(52) U.S. Cl. 707/104.1; 707/E17.127

(57) ABSTRACT

A method, system and computer program product for testing a Middleware based application, including providing XML or XSD data and generating an XML template from the XML or XSD data, generating a test data template from the XML template, and generating XML values from the test data template. The XML values may be published over a Middleware based application. A query may be built in a application database wherein the data base is in communication with the Middleware based application. The queries may be executed by fetching data from the database. The method, system and computer program product may further include validating test data and subscribing to an application output. After validating the subscribed output against an expected output, a test result may be generated.

### BACKGROUND OF THE INVENTION

1. Field of the Invention

The present invention generally relates to the field of end to end testing solutions for software systems, and more particularly, to a system and method for testing Middleware based applications.

2. Discussion of the Background

The ability of business users to access crucial business information has been greatly enhanced by the proliferation of IP-based networking together with advances in object oriented Web-based programming and browser technology. Using these advancements, systems have been developed that permit web-based access to business information systems, thereby allowing any user with a browser and an Internet or intranet connection to view, enter, or modify the required business information.

A company's information technology (IT) base may consist of multiple software applications which serve various IT needs. In many instances, it is desirable to integrate these applications, for example, to gain a significant business advantage. Middleware has been provided as a core of this integration. Thus, numerous applications may be integrated through a Middleware program. Hence, data may be passed over the middleware by one application and received by another application. The data can be stored in a database, processed (for example, using business logic) and a output or result may be produced from the aforementioned processing.

However, testing applications based on such architecture has proven to be challenging and rather new to the industry. Testing solutions in the market are mature at testing applications that are based on well known protocols such as “http”. However, a comprehensive testing solution for Middleware based applications does not exist.

Furthermore, testing an application, such as one in an integrated suite, requires that the other applications of the integrated suite are also available. (This is, at least in part, because each of the integrated applications functions with the data provided by the other. Thus, it can be difficult and costly to make all the applications available, in order to test every one of them. Even if every integrated application were available, it may still be a daunting task to test, because one is required to have knowledge of or readily know each of the applications, prepare test cases on each of the applications, and maintain each application in the test environment including the required costs associated with providing the aforementioned setup etc.

Some solutions have been developed which can generate Extensible Markup Languages (XMLs) from schemas or XML schema (XSDs), create valid XML messages, and publish them over the Middleware. For example, one commercially known tool for message publishing and subscribing is GH Tester, from Green Hat consulting. However GH Tester is not only expensive but also suffers from other limitations including, for example, lacking an ability to understand XML schemas or XSDs and generating XML templates therefrom. GH Tester also lacks the capability to generate test data templates based on XML templates. In addition, GH Tester lacks the capability to automatically correlate columns in the test data with the elements in the XML. Furthermore, generating messages with GH Tester has been known to be very time consuming and monotonous. Other concerns include the fact that messages can only be generated at publish time, and the generated messages cannot be stored automatically. Additionally, validating the database using GH Tester takes much more time and effort than manual verification. It requires Structured Query Language (SQL) queries to be supplied at each XML attribute level. Also, validating subscribed XML messages can also be difficult. As importantly, GH Tester provides no extensibility and very minimal scripting capabilities. GH Tester is still in an evolving state and has been described as having many defects in itself. Moreover, GH Tester is not regarded as being user friendly. Finally, GH Tester simply does not address the end to end testing needs as may be required business users.

Concerns and/or limitations of the XML generation tools include that each XML has to be generated manually. The Generated XMLs have default values which, again, need to be populated manually with specific data. These tools cannot be integrated to form a testing solution.

Thus, there is a need to address and provide a comprehensive testing solution for Middleware based applications.

### SUMMARY OF THE INVENTION

The above and other needs are addressed by the present invention which provides, for example, a method and system for testing a Middleware based application.

In exemplary embodiments, a method, system and computer program product are provided which include XML or XSD data and generating an XML template from the XML or XSD data. The a method, system and computer program product may also include generating a test data template from the XML template and generating XML values from the test data template. The XML values may be published over a Middleware based application. A query may be built in a application database wherein the data base is in communication with the Middleware based application. The queries may be executed by fetching data from the database. The a method, system and computer program product may further include validating test data and subscribing to an application output. After validating the subscribed output against an expected output, a test result may be generated.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary testing solution functionality, according to an exemplary embodiment of the present invention; and

FIG. 2 illustrates an exemplary end to end testing solution, according to an exemplary embodiment of the present invention.

### DETAILED DESCRIPTION OF THE PREFERRED EMBODIMENTS

Exemplary embodiments address and provide a comprehensive testing solution for Middleware based applications. Disclosed embodiments of the invention are directed at automating an entire applications suite testing activity. This may significantly reduce large amounts of man power and associated costs, thereby enhancing the quality of testing and also ensuring the quality of the application under test. Thus, the disclosed solution of the invention provides an economic alternative than making each application of the integrated set available.

Disclosed embodiments include a solution which works at a low level, i.e., at the level of messages. It generates XMLs from schemas or XSDs, creates valid XML messages, publishes them over the middleware, validates the database of the receiving application, subscribes to the content over the middleware and also validates the subscribed messages, based on inputs given by testers. This solution acts as a framework that tests applications based on Tibco Middleware, with XML messaging and enables extensibility and customization specific to the needs.

Exemplary embodiments of the invention leverage on the benefits of existing tools, combines them into one comprehensive end to end testing solution and adds additional functionalities unavailable in the existing tools.

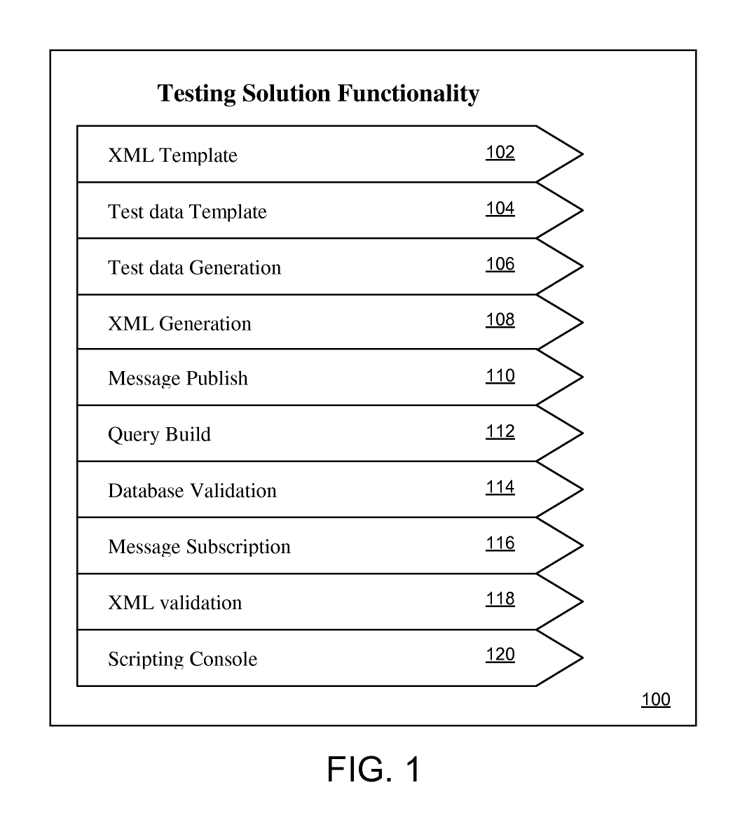

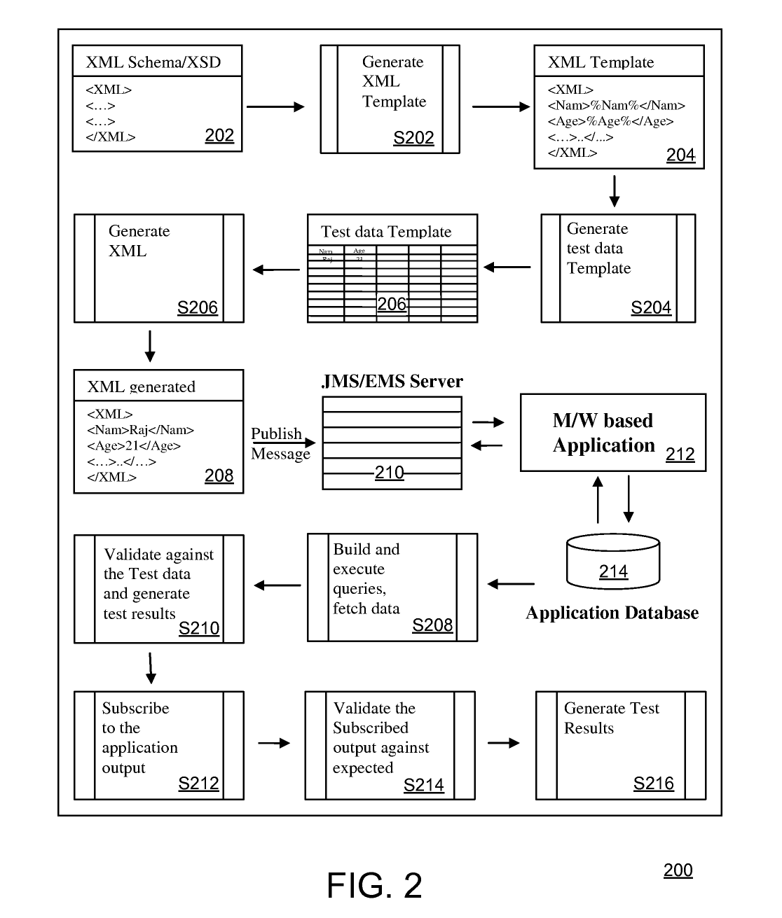

Referring now to the drawings, wherein like reference numerals designate identical or corresponding parts throughout the several views, and more particularly to FIGS. 1-2 thereof, which will be used to illustrate exemplary embodiments of the present invention.

FIG. 1 illustrates the testing solution functionality 100, according to an exemplary embodiment of an end to end testing solution. An XML Template 102 is provided wherein a test data template 104 is produced. Test data 106 may be generated whereupon XML 108 is generated therefrom. The disclosed solution publishes messages 110, such as via the Middleware application, and also provides a query build 112. The database is validated 114 and a message subscription 116 is provided whereupon XML validation 118 may be confirmed. Finally, a scripting console 120 is provided such as for generating test results.

Turning to FIG. 2, a process flow of an exemplary end to end testing solution is illustrated. XML or XML schema (XSDs) data 202 is provided. In one embodiment, the data 202 may exist, for example, in a spreadsheet format. In step S202, an XML template 204 is generated from the data provided via the XML schemas or XML schema (XSDs) data 202. In step S204, a test data template 206 is generated from the XML template 204. In step S206, XML data 208 is generated from data as provided via the test data template 206. The generated XML data 208 or data messages produced therefrom may be published over a Middleware based application 212 such as via appropriate computer equipment. In one embodiment, a java messaging service (JMS) server or Enterprise Message Service (EMS) server may be provided to publish the aforementioned data 208 or data messages. A query is built in the application database 214 which may also be configured in communication with the Middleware based application. Thus, step S208 builds and executes queries and fetches data in order to perform step S210 which provides validation against the test data (such as that produced via the XML data 208) in order to generate test results. A subscription to the application output is performed in step S212 whereby step S214 is performed. In step S214, the subscribed output is validated against the expected results. The disclosed embodiment produces or generates test results in step S216 subsequent to the validation in step S214.

Thus, the invention is capable of overcoming the limitations of the prior art solutions and testers, such as GH tester, in numerous ways. Disclosed aspects of the invention generate XML templates from XML schemas or XSDs. Disclosed embodiments can generate XMLs in two modes, one with default values based on the rules set in the schema or XSD and the other based on the rules set by users. In an exemplary embodiment, disclosed aspects of the invention can generate test data templates (.xls, .csv, .txt etc.) with the values in the XML elements as the column headers, for example, within a spreadsheet document, and automatically correlate the XML elements with the test data by matching the column headers with the XML tags. Another step is performed which automatically replaces the tags in XML templates with the data from the test data. Thus, XMLs may be generated in this manner. Additional aspects of the disclosure include automatically storing the generated XMLs in a configured path. The generated XMLs may also be published, for example, to a JMS based Middleware.

In an exemplary embodiment, the disclosed testing solution takes in a data dictionary as an input to identify the database table and column names for each of the attributes in the XML. The testing solution can then generate SQL queries in two modes, one automatically by identifying the relationships in the database and the other by using the SQL queries supplied by testers. By doing so, the specific needs of an application may be addressed. Once the queries are available and the database details are configured, the solution is capable of fetching data stored in the database. It may also verify the data fetched from the database against the data (XML) published to the Middleware. The disclosed testing solution may also store the results of the aforementioned verification.

In an exemplary embodiment, the disclosed testing solution may also subscribe to messages over the Middleware and verify them against expected outputs prepared by testers/users. In one embodiment, the testing solution includes a framework and is, therefore, customizable to address specific needs. Additional aspects of the testing solution including the ability to enable scripting and is preferably aimed at being user friendly. As importantly, the testing solution provides comprehensive automated end to end testing and is capable of reducing extensive manual efforts which are prone to errors.

The invention also overcomes limitations of XML generation tools. For example, the XML generation activity, of the disclosed testing solution, is automated. Hence, any number of XMLs can be generated automatically. In an exemplary embodiment, the testing solution has two modes. It can generate XMLs with default values and also generate XMLs having values based on custom specified rules. The disclosed testing solution is further configurable to integrate this process with the entire testing process.

Thus, the disclosed testing solution addresses the end to end testing needs for Middleware based applications. Other prior art tools do not provide the end to end capabilities as disclosed herein. The disclosed testing solution provides features which automate various activities (for example, as described above) which are otherwise done manually. This manual process typically consumes extensive man power and may extend completion over an undesired amount of time. The invention operates and is integrated in line with a natural flow of Middleware testing. Thus, the best process to test middleware based applications is inherent in the disclosed solution. This is an improvement over other prior art solutions and testing approaches which are often regarded as having multiple inefficient approaches. For example, in one embodiment, the testing solution tests applications which function on published dates over Middleware and provides additional capabilities for uniquely testing Middleware.

Thus, the disclosed testing solution provides end to end testing capabilities including directly from test data preparation to test execution. It provides a best practice solution for testing Middleware based applications while also providing significant cost cutting solutions. Further, the solution is capable of working at a message(or data) level.

In summary, an exemplary embodiment of the disclosed testing solution provides integration of various aspects of testing applications which may include a two mode XML generation from schemas (with default values or values based on rules), generation of test data templates from XML, generation of XMLs and storing them, message publishing and subscribing, testing application persistence (data storage), results capturing, two mode database query generation (automatic and manual), and verification of subscribed XMLs against expected results.

The above-described devices and subsystems of the exemplary embodiments of FIGS. 1-2 can include, for example, any suitable servers, workstations, PCs, laptop computers, PDAs, Internet appliances, handheld devices, cellular telephones, wireless devices, other devices, and the like, capable of performing the processes of the exemplary embodiments of FIGS. 1-2. The devices and subsystems of the exemplary embodiments of FIGS. 1-2 can communicate with each other using any suitable protocol and can be implemented using one or more programmed computer systems or devices.

One or more interface mechanisms can be used with the exemplary embodiments of FIGS. 1-2, including, for example, Internet access, telecommunications in any suitable form (e.g., voice, modem, and the like), wireless communications media, and the like. For example, the employed communications networks can include one or more wireless communications networks, cellular communications networks, 3 G communications networks, Public Switched Telephone Network (PSTNs), Packet Data Networks (PDNs), the Internet, intranets, a combination thereof, and the like.

It is to be understood that the devices and subsystems of the exemplary embodiments of FIGS. 1-2 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 1-2 can be implemented via one or more programmed computer systems or devices.

To implement such variations as well as other variations, a single computer system can be programmed to perform the special purpose functions of one or more of the devices and subsystems of the exemplary embodiments of FIGS. 1-2. On the other hand, two or more programmed computer systems or devices can be substituted for any one of the devices and subsystems of the exemplary embodiments of FIGS. 1-2. Accordingly, principles and advantages of distributed processing, such as redundancy, replication, and the like, also can be implemented, as desired, to increase the robustness and performance the devices and subsystems of the exemplary embodiments of FIGS. 1-2.

The devices and subsystems of the exemplary embodiments of FIGS. 1-2 can store information relating to various processes described herein. This information can be stored in one or more memories, such as a hard disk, optical disk, magneto-optical disk, RAM, and the like, of the devices and subsystems of the exemplary embodiments of FIGS. 1-2. One or more databases of the devices and subsystems of the exemplary embodiments of FIGS. 1-2 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-2 can include appropriate data structures for storing data collected and/or generated by the processes of the devices and subsystems of the exemplary embodiments of FIGS. 1-2 in one or more databases thereof.

All or a portion of the devices and subsystems of the exemplary embodiments of FIGS. 1-2 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 1-2 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 1-2, for driving the devices and subsystems of the exemplary embodiments of FIGS. 1-2, for enabling the devices and subsystems of the exemplary embodiments of FIGS. 1-2 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 1-2. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 1-2 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention has been described in connection with a number of exemplary embodiments and implementations, the present invention is not so limited, but rather covers various modifications and equivalent arrangements, which fall within the purview of the appended claims.

The present description is the best presently-contemplated method for carrying out the present invention. While the following description is presented to enable a person of ordinary skill in the art to make and use the invention and is provided in the context of the requirement for a obtaining a patent, various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

Accordingly, the foregoing description of the present invention should be considered as merely illustrative of the principles of the present invention and not in limitation thereof.

What we claim is:

1. A method for testing a Middleware based application, the method comprising:
providing XML or XSD data;
generating an XML template from said XML or XSD data,
generating a test data template from the XML template;
generating XML values from the test data template;
publishing the XML values over a Middleware based application;
building a query in an application database wherein the data base is in communication with said Middleware based application;
executing said queries by fetching data from said database;
validating test data;
subscribing to an application output;
validating the subscribed output against an expected output; and
generating a test result.

2. The method of claim 1, wherein the XML values are generated in one of two modes, the first mode having default values based on rules set in schemas or XSD data and the other mode being based on rules set by users.

3. The method of claim 1, wherein XML elements are generated in the test data templates as column headers.

4. The method of claim 3, further comprising:
correlating the XML elements with the test data by matching the column headers with XML tags.

5. The method of claim 4, further comprising:
automatically replacing the tags in XML template with the data from the test data.

6. The method of claim 5, further comprising:
automatically storing the generated XML values in a configured path.

7. The method of claim 1, further comprising:
publishing the generated XML values via a java messaging service (JMS) based Middleware.

8. The method of claim 1, wherein the method for testing is performed automatically.

9. The method of claim 1, wherein the method provides an end to end testing solution for Middleware based applications.

10. A system for testing a Middleware based application, the system comprising:
means for providing XML or XSD data;
means for generating an XML template from said XML or XSD data,
means for generating a test data template from the XML template;
means for generating XML values from the test data template;
means for publishing the XML values over a Middleware based application;
means for building a query in an application database wherein the data base is in communication with said Middleware based application;
means for executing said queries by fetching data from said database;
means for validating test data;
means for subscribing to an application output;
means for validating the subscribed output against an expected output; and
means for generating a test result.

11. The system of claim 10, wherein the XML values are generated in one of two modes, the first mode having default values based on rules set in schemas or XSD data and the other mode being based on rules set by users.

12. The system of claim 10, wherein XML elements are generated in the test data templates as column headers.

13. The system of claim 12, further comprising:
means for correlating the XML elements with the test data by matching the column headers with XML tags.

14. The system of claim 13, further comprising:
means for automatically replacing the tags in XML template with the data from the test data.

15. The system of claim 14, further comprising:
means for automatically storing the generated XML values in a configured path.

16. The system of claim 10, further comprising:
means for publishing the generated XML values via a java messaging service (JMS) based Middleware.

17. The system of claim 10, wherein the system for testing is performed automatically.

18. The system of claim 10, wherein the system provides an end to end testing solution for Middleware based applications.

19. A tangible computer-readable medium having stored thereon computer executable instructions for testing a Middleware based application, the computer-readable medium comprising program code for performing the steps of:
providing XML or XSD data;
generating an XML template from said XML or XSD data,
generating a test data template from the XML template;
generating XML values from the test data template;
publishing the XML values over a Middleware based application;
building a query in an application database wherein the data base is in communication with said Middleware based application;
executing said queries by fetching data from said database;
validating test data;
subscribing to an application output;
validating the subscribed output against an expected output; and
generating a test result.

20. The computer-readable medium of claim 19, wherein the XML values are generated in one of two modes, the first mode having default values based on rules set in schemas or XSD data and the other mode being based on rules set by users.

21. The computer-readable medium of claim 19, wherein XML elements are generated in the test data templates as column headers.

22. The computer-readable medium of claim 21, further comprising:
correlating the XML elements with the test data by matching the column headers with XML tags.

23. The computer-readable medium of claim 22, further comprising:
automatically replacing the tags in XML template with the data from the test data.

24. The computer-readable medium of claim 23, further comprising:
automatically storing the generated XML values in a configured path.

25. The computer-readable medium of claim 19, further comprising:
publishing the generated XML values via a java messaging service (JMS) based Middleware.

26. The computer-readable medium of claim 19, wherein the method for testing is performed automatically.

27. The computer-readable medium of claim 19, wherein the method provides an end to end testing solution for Middleware based applications.
